(19) United States
(12) Patent Application Publication
(10) Pub. No.: US 2023/0312833 A1
(43) Pub. Date: Oct. 5, 2023

(54) PROCESS FOR PREPARING FREE-RADICAL CURED SILICONE RELEASE COATINGS

(71) Applicant: Evonik Operations GMBH, Essen (DE)

(72) Inventors: Scott Ronald STEUDLE, Howell, MI (US); Brian Ray Chambers (Deceased), Fort Wayne, IN (US)

(73) Assignee: Evonik Operations GmbH, Essen (DE)

(21) Appl. No.: 18/041,426

(22) PCT Filed: Aug. 12, 2021
(86) PCT No.: PCT/US2021/045646

§ 371 Date: Feb. 13, 2023

Related U.S. Application Data
(60) Provisional application No. 63/065,758, filed on Aug. 14, 2020.

(30) Foreign Application Priority Data
Sep. 22, 2020 (EP) 20197538.0

(51) Int. Cl. C08G 77/20; C08K 5/101; C09D 183/06; C09D 4/06

(52) U.S. Cl. CPC C08G 77/20; C08K 5/101; C09D 183/06; C09D 4/06

(57) ABSTRACT

A method can be used for curing and/or manufacturing silicone-coated release liners, which can be used in the production of pressure sensitive, peel-and-stick labels. The corresponding silicone release coatings are curable by LED. A method for preparing silicone release coatings and curing such coatings can be performed with or without the need for nitrogen inerting or the addition of oxygen scavengers.

### FIELD OF THE INVENTION

The present invention generally relates to methods for curing and/or manufacturing silicone-coated release liners used e.g., in the production of pressure sensitive, peel-and-stick labels. In particular, the present invention is directed to silicone release coatings curable by LED, and methods for preparing silicone release coatings and curing such coatings with or without the need for nitrogen inerting or the addition of oxygen scavengers.

### BACKGROUND OF THE INVENTION

Labels play an important role in today's economy. The annual global production of pressure sensitive labels is approximately 25 billion square meters and is expected to grow annually more than 4-5% through 2025.

A standard pressure sensitive label consists of (1) a silicone coated release liner, (2) a pressure sensitive adhesive and (3) a printed face-stock.

A high-quality release liner enables high-speed production and precise label application. Made from paper, film or other materials, release liners typically require silicone coatings to provide smooth, easy non-stick properties. Clear labels require film substrates for clarity reasons. Additionally, film offers a desirable silicone hold out, decreasing the amount of silicone required. The down gauging of film liners reduces material consumption, leading to less waste and improved sustainability.

Silicone polymers typically used in release liner generally has a polydimethylsiloxane (PDMS) base polymer with end-blocked functionalities. Currently, the two most widely used curing processes include the use of radiation curable silicone and thermal cure silicone. In thermally cure systems, silane functionalized PDMS reacts with hydroxyl or vinyl groups in the presence of heat and an organometallic catalysts to generate the silicone release liner. In radiation cure systems, silicone release liner can be made using either the cationic curing mechanism or the free radical curing mechanism. In the cationic radiation curing system, irradiation of a photoinitiator generates a cationic photoinitiator which in turns polymerizes the cycloaliphatic epoxide functionalized PDMS to generate the silicone release liner. In the free radical radiation curing system, irradiation of a photoinitiator generates free radicals which in turns polymerizes the acrylate functionalized PDMS to generate the silicone release liner.

The application of free-radical, radiation-curable silicone coatings for the fabrication of release liners continues to grow. The advantages of this technology over thermal cure silicones are significant and numerous. UV curing of free-radical silicones at room temperature means less consumption of energy and lower thermal stress to the substrate, allowing for the use of many different heat sensitive materials, like thin film liners or thermal paper. Low heat also means that traditional paper substrates maintain their moisture to ensure excellent lay-flat behavior.

The process of free radical polymerization, in which highly reactive free radicals drive a chain-growth reaction, is the dominate UV curing technology. Silicone polymers with (meth)acrylate functionality useful in free radical curing are described in detail in U.S. Pat. Nos. 6,211,322; 6,268,404 and 10,465,032. However, early chain termination can occur when radical molecules react with airborne oxygen, resulting in an incomplete cure at air exposed surfaces. This oxygen inhibition is particularly devastating in silicone release coatings due to the thin application layer and the high diffusion of oxygen through the silicone.

To avoid oxygen inhibition and provide complete cure of the silicone coating, the process must be run under a nitrogen inerted atmosphere. In a typical roll-to-roll application, the silicone coated substrate is passed through specially designed, UV light chambers that are flushed with high-purity nitrogen to reduce oxygen levels below 50 ppm. Alternatively, additives such as trivalent phosphites are used to scavenge oxygen so as to avoid early termination of the curing process. Inertization and additives add a level of complexity and cost to the free-radical curing process.

U.S. Pat. No. 7,105,584 discloses a dual-cure composition useful to make encapsulating/potting compounds. The dual-cure silicone exhibits both UV- and moisture initiated curing mechanisms, with the UV-initiated curing providing very rapid curing that does not require nitrogen inerting, followed by a second moisture-induced polymerization. There is no disclosure in U.S. Pat. No. 7,105,584 for silicone release coatings, however.

In fact, the dual-cure compositions described cannot be used as release coatings due to the presence of the secondary moisture cure, which would typically cause a problem with post cure. Should a silicone release coating continue to cure post exposure to the UV radiation (i.e., post cure), the properties will change with time which will negatively impact the performance.

U.S. Pat. No. 9,981,458 for Controlled Silicon Release During Xerographic Printing to Create Pressure Sensitive Adhesive Release Coat discloses a process to apply pressure sensitive adhesive to cut sheet media and eliminate a separate release liner. A silicone release layer is applied during fusing on a top surface of cut media and then UV cured. However, there is no disclosure in U.S. Pat. No. 9,981,458 for a free-radical cured silicone release coating.

U.S. Pat. No. 10,029,816 for Pressure Sensitive Labels for Use in a Cold Transfer and Process for Making discloses such a label for garment identification and labeling. However, there is no disclosure in U.S. Pat. No. 10,029,816 for a free-radical cured silicone release coating.

U.S. Pat. No 7,893,128 describes as process for producing cationic curing silicones useful in the manufacture of release coatings that are not sensitive to oxygen inhibition due to the cationic reaction mechanism and therefore do not require nitrogen inerting. Silicone release coatings based on this technology are currently commercially available and are sometimes used as an alternative to free-radical cure. The cationic cure chemistry, however, presents several potential problems, including post curing, and the possibility for the reaction to be poisoned by chemical interference.

Breit Technologies (https://breit-tech.com) describes its Cast and Cure™ (C2™) decorative coating process to form a surface that can include high gloss, matte and holographic finishes on substrates. However, there is no disclosure therein for its use in a free-radical cured silicone release coating.

Although processes for UV curing of free-radical silicone high quality release liners are available in the art, there is a need in the art to provide for a less complex and more cost-effective UV curing process for free-radical silicone high quality release liners.

### SUMMARY OF THE INVENTION

The present invention is directed to novel methods for curing and/or preparing silicone release liners without nitrogen inertization or the use of any oxygen scavenging agent as well as novel compositions and methods for using said compositions for preparing silicone-coated release liners with LED curing. Therefore, in the first aspect, the invention provides the following:
1.1 a composition comprising, based on the total weight of the composition, (A) 70-95 wt. % of a composition which contains at least one siloxane having ethylenically unsaturated, radically-polymerizable groups said reactive groups may be either terminal or pendant on the polysiloxane backbone, e.g., as described herein; (B) 0-10 wt. % of an acrylic organic compound; preferably (C) 1 to 5 wt. % of an acrylated synergist; and (D) 1-8 wt. % of a photoinitiator;
1.2 the composition of formula 1.1, wherein component (A) is present at 75-95 wt. %, in another embodiment, at 85-95 wt. %, in still another embodiment, 72-89 wt. %, in yet another embodiment, selected from 87 wt. %, 90 wt. % and 94 wt. %, based on the total weight of the composition;

1.3 the composition of formula 1.1 or 1.2, wherein component (A) is a (meth)acrylated polydiC₁₋₈alkylsiloxane, in another embodiment, (meth)acrylated polydimethylsiloxane, in still another particular embodiment, selected from siloxanes and silicones, di-Me, hydrogen-terminated, reaction products with acrylic acid and 2-ethyl-2-[(2-propenyloxy)methyI]-1,3-propanediol (e.g., TEGO® RC 902, TEGO® RC 922), in another embodiment, the acrylated polydimethylsiloxane is siloxanes and silicones, 3-[3-(acetyloxy)-2-hydroxypropoxy]propyl Me, di-Me, 3-[2-hydroxy-3-[(1-oxo-2-propen-1-yl)oxy]propoxy]propyl Me (e.g., TEGO® RC 711, TEGO® RC 715 and TEGO® SB6705);
1.4 the composition of any of formulae 1.1-1.3, wherein the acrylic organic compound is present at 0-10 wt. %, in another embodiment, 0-5 wt. %, in another embodiment, 5-7 wt. %, in yet another embodiment, selected from 3 wt. % and 7 wt. %;
1.5 the composition of any of formulae 1.1-1.4, wherein the acrylic organic compound is (i) an organic compound comprising ethylenically unsaturated, radically polymerizable group, preferably (meth)acrylated function or (ii) a trimethylolpropane triacrylate (TMPTA), or 1,6-Hexanediol diacrylate (HDDA), or (iii), a low viscosity, tetra-functional polyol acrylate such as Ebecryl® 45;
1.6 the composition of any of formulae 1.1-1.5, wherein the acrylated synergist is present at 1-5 wt. %, in another embodiment, 1-3 wt. %, in another embodiment, selected from 1 wt. % and 5 wt. %;
1.7 the composition of any of formulae 1.1-1.6, wherein the acrylated synergist is a mercapto synergist, in one embodiment, a mercapto modified polyester acrylate resin that is added as a coresin and when combined with appropriate photoinitiators provides formulations curable with UV LED, in another embodiment, the mercapto synergist is Ebecryl® LED 02;
1.8 the composition of any of formulae 1.1-1.6, wherein the acrylated synergist is an oligoamine synergist, in another embodiment, an amine modified polyether acrylate oligomer that is added as a coresin, in a particular embodiment, the oligoamine synergist is selected from Ebecryl® LED 03 and GENOMER 5142;
1.9 the composition of any of formulae 1.1-1.8, wherein the photo initiator is present in 1-3 wt. %., in a particular embodiment, 2 wt. %, based on the total weight of the composition;
1.10 the composition of any of formulae 1.1-1.9, wherein the photo initiator is selected from any commercially available photoinitiators with the characteristics that they are both soluble in the (meth)acrylate polydimethyl siloxane and have an absorption spectra that overlaps the emission spectra of the lamp system, in a particular embodiment, the photoinitiator is a special blended photoinitiator combination comprising bis(2,4,6-trimethylbenzoyl)phenylphosphine oxide, ethyl(2,4,6-trimethylbenzoyl)-phenylphosphinate and 2-hydroxy-2-methyl-1-phenylpropanone, in a particular embodiment, the photo initiator is Omnirad 2100 from IGM Resins.

In the second aspect, the invention provides the following:
2.1 a method for curing and/or preparing a silicone-coated release liner comprising the steps of (i) applying an ultraviolet or electron beam (UV/EB) curable silicone composition, e.g., as described herein, to a substrate, in a particular embodiment, the UV/EB curable silicone composition comprises a (meth)acrylated polysiloxane, in another embodiment, the UV/EB curable silicone composition is the composition of the invention (e.g., any of formulae 1.1-1.10); (ii) laminating a UV/EB transparent protective film to the coated substrate of step (i); and (iii) exposing the laminated combination of step (ii) to ultraviolet (UV) or electron beam (EB) radiation;
2.2 the Method of formula 2.1, wherein the UV/EB transparent protective film is selected from a polypropylene film, polyethylene film and a Cast and Cure® film available from Breit Technologies, in a particular embodiment, the film is a decorative film, in another particular embodiment, the film is non-decorative film, in still another embodiment, such film provides a matt, glossy or ultra high gloss finish;
2.3 the Method of formula 2.1 or 2.2, wherein the laminated combination of step (ii) is exposed to a UV radiation source;
2.4 the Method of any of formulae 2.1-2.3, wherein the UV/EB curable silicone composition is a UV curable silicone composition, preferably comprising a (meth)acrylated polysiloxane and a photoinitiator, and the laminated combination of step (ii) is exposed to mercury vapor lamp UV radiation, in a particular embodiment, with an output of UV light in the range of 220-400 nm;
2.5 the Method of any of formulae 2.1-2.3, wherein the UV/EB curable silicone composition is the composition of the invention (e.g., any of formulae 1.1-1.10) and the laminated combination of step (ii) is exposed to light emitting diodes (LED), in one embodiment, with an output of UV light in the range of 350-405 nm, in another embodiment, with an output of UV light in the range of 385-405 nm;
2.6 the Method of any of formulae 2.1-2.3, wherein the UV/EB curable silicone composition is an EB curable silicone composition, preferably comprises a (meth)acrylated polysiloxane, and the laminated combination of step (ii) is exposed to electron beam radiation source;
2.7 the Method of any of formulae 2.1-2.6, wherein said substrate has a surface energy of greater than 40 dynes, in a particular embodiment, the substrate is corona treated;
2.8 the Method of any of formulae 2.1-2.7, wherein said substrate is a paper-based or polymer-based film sheet;
2.9 the Method of any of formulae 2.1-2.8, wherein the substrate is a polymer-based film;
2.10 the Method of any of formulae 2.1-2.8, wherein the substrate is selected from the group consisting of polypropylene, polyethylene, polyethylene terephthalate (PET), polyester, bi-axially oriented polypropylene (BOPP), biaxially-oriented polyethylene terephthalate (BoPET), high density polyethylene, low density polyethylene and polypropylene plastic resins;
2.11 the Method of any of formulae 2.1-2.8, wherein the substrate is a paper-based film;
2.12 the Method of any of formulae 2.1-2.8, wherein the substrate is selected from the group consisting of super calendered Kraft (SCK), glassine, clay coated Kraft and machine glazed paper;
2.13 the Method of any of formulae 2.1-2.12, wherein the substrate is treated with a polyolefin material;
2.14 the Method of any formulae 2.1-2.13, wherein the substrate is a direct thermal, or thermal transfer paper useful in producing thermal linerless labels;
2.15 the Method of any of formulae 2.1-2.14, wherein the entire coated combination of step (ii) is pass over a cylindrical compression drum prior to exposure under the actinic ration source (e.g., UV or EB radiation);
2.16 the Method of any of formulae 2.1-2.15, wherein the laminated combination of step (ii) passes over a compression cylinder;
2.17 the Method of any of formulae 2.1-2.16, further comprising step (iv) delaminating the UV/EB transparent protective film from the UV/EB cured silicone coated substrate;
2.18 the Method of any of formulae 2.1-2.17, wherein said method does not require gas inertization, in a particular embodiment, said method does not require nitrogen inerting;
2.19 the Method of any of formulae 2.1-2.18, wherein said method does not require an oxygen scavenging agent.

In a third aspect, the invention provides a silicone release liner made from the Method of any of formulae 2.1-2.19.

In a fourth aspect, the invention provides a silicone release liner comprising a substrate, having on its surface, a coating of an ultraviolet or electron beam (UV/EB) curable silicone composition, in one embodiment, the UV curable silicone composition comprises a (meth)acrylated polysiloxane, in another embodiment, the UV/EB curable silicone composition is the Composition of any of formulae 1.1-1.10.In a further embodiment, the release liner has been cured, e.g., by exposure to ultraviolet (UV) or electron beam radiation, with or without inerting and/or oxygen scavenging agent. In one embodiment, the coated substrate is exposed to mercury vapor lamp UV radiation, in a particular embodiment, with an output of UV light in the range of 200-400 nm. In another embodiment, the substrate is exposed to light emitting diode (LED) UV radiation, in still another embodiment, with an output of UV light in the range of 350-405 nm, in another embodiment, with an output of UV light in the range of 385-405 nm. In a further embodiment, the substrate is a paper-based or polymer-based film sheet. In another further embodiment, the substrate is selected from the group consisting of polypropylene, polyethylene, polyethylene terephthalate (PET), polyester, bi-axially oriented polypropylene (BOPP), biaxially-oriented polyethylene terephthalate (BoPET), high density polyethylene, low density polyethylene and polypropylene plastic resins. In still another embodiment, the substrate is selected from the group consisting of super calendered Kraft (SCK), glassine, clay coated Kraft and machine glazed paper. In another embodiment, the substrate is corona treated. In still another embodiment, the silicone release liner is an adhesive label, in yet another embodiment, the silicone release liner is a pressure sensitive adhesive label. In still another embodiment, the peel-and-stick label is a silicone-coated, thermal linerless label.

### DESCRIPTION OF THE FIGURES

The forgoing and other features, aspects and advantages of the present invention will become better understood with regard to the following description, appended claims, and accompany sole figure where it provides for a detailed apparatus showing the process of free-radical polymerization curing of the UV/EB curable release coating composition laminated between a UV/EB transparent protective film and the substrate according to the invention.

FIG. 1 shows a schematic representation of the process for preparing a silicone release liner according to the invention. UV/EB curable silicone coating compositions 10 coated onto release liner substrate 15 is passed through entering conveying platform 20. Entering UV/EB transparent protective film 25 on top of entering release liner substrate 15 having the UV/EB curable silicone coating composition\10 laminated between them passes between a first guiding cylinder 30 and entering conveying platform 20. The resulting coated release liner is then passed below UV/EB curing lamp 35 and above one side of compression cylinder 40, and then exits to the other side of compression cylinder 40. The resulting coated release liner passes under second guiding cylinder 45 and is separated into exiting reusable UV/EB transparent protective film 50 on one side and exiting release liner 55 having cured UV/EB curable silicone coating composition 60 on top of the exiting release liner substrate, and over exiting conveying platform 65

### DETAILED DESCRIPTION OF THE INVENTION

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing of the present invention. All publications, patent applications, patents and other references mentioned herein are incorporated by reference in their entirety. The materials, methods, and examples disclosed herein are illustrative only and not intended to be limiting.

The terms “comprise(s),” “include(s),” “having,” “has,” “can,” “contain(s),” and variants thereof, as used herein, are intended to be open-ended transitional phrases, terms, or words that do not preclude the possibility of additional acts or structures. The singular forms “a,” “an” and “the” include plural references unless the context clearly dictates otherwise. The present disclosure also contemplates other embodiments “comprising,” “consisting of” and “consisting essentially of,” the embodiments or elements presented herein, whether explicitly set forth or not.

The conjunctive term “or” includes any and all combinations of one or more listed elements associated by the conjunctive term. For example, the phrase “a composition comprising A or B” may refer to a composition including A where B is not present, a composition including B where A is not present, or a composition where both A and B are present. The phrases “at least one of A, B, . . . and N” or “at least one of”A, B, . . . N, or combinations thereof' are defined in the broadest sense to mean one or more elements selected from the group comprising A, B, . . . and N, that is to say, any combination of one or more of the elements A, B, . . . or N including any one element alone or in combination with one or more of the other elements which may also include, in combination, additional elements not listed.

The term “(meth)acrylate” or “(meth)acrylated” shall refer to acrylate(d) and/or methacrylate(d), preferably, acrylate(d).

This invention is directed to novel methods for curing and/or preparing silicone release liners without nitrogen inertization or the use of any oxygen scavenging agent as well as novel compositions and methods for curing and/or preparing silicone-coated release liners, as well as silicone release liners made from such novel methods of the invention.

It is believed that the invention solves an unmet need in the art by providing novel compositions curable by using LED irradiation rather than the traditional mercury vapor lamp (i.e., LED curable silicone composition), as well as novel methods for preparing silicone release liners with or without having the need for inerting or adding oxygen scavenging agents in the system, but via mechanical inerting.

The methods of the invention involve free-radical polymerization curing of a UV/EB curable silicone composition laminated between a UV/EB transparent protective film and the substrate with or without, preferably without the need for gas inerting or the use of oxygen scavenging agents in the system. The substrates useful for the methods of the invention may be paper-based or polymer-based film or similar material. For example, the substrate may be made of polypropylene, polyethylene, polyethylene terephthalate (PET), polyester, bi-axially oriented polypropylene (BOPP), biaxially-oriented polyethylene terephthalate (BoPET), high density polyethylene, low density polyethylene and polypropylene plastic resins. In another embodiment, the substrate may be selected from the group consisting of super calendered Kraft (SCK), glassine, clay coated Kraft and machine glazed paper. In still another embodiment, the foregoing substrate may be treated with a polyolefin material. In yet another embodiment, the foregoing substrate may further be corona treated to enhance surface bonding with the coating compositions of the invention.

The UV/EB curable silicone compositions useful for the methods of the invention may be any UV/EB curable silicone compositions known in the art that are silicone acrylate based and cure by way of a free-radical mechanism. In one embodiment, the UV/EB curable silicone compositions useful for the methods of the invention include those that comprises a (meth)acrylated polysiloxane known in the art. Wherein the methods are cured by EB radiation, then the UV/EB curable silicone composition of the invention is an EB curable silicone composition which preferably comprises a (meth)acrylated polysiloxane known in the art without the need for a photoinitiator. Wherein the methods are cured by UV radiation, the UV/EB curable silicone composition of the invention is an UV curable silicone composition which preferably comprises a (meth)acrylated polysiloxane and a photoinitiator. Examples of UV curable silicone compositions include but are not limited to those disclosed in U.S. Pat. Nos. 6,211,322; 6,268,404, and 10,465,032, the contents of which are incorporated by reference in their entirety.

Wherein the methods of the invention are cured by LED UV radiation, the UV/EB curable silicone composition of the invention is the compositions of the invention (i.e., compositions of any of formulae 1.1-1.10), which comprise (i) a composition which contains at least one siloxane having ethylenically unsaturated, radically-polymerizable groups said reactive groups may be either terminal or pendant on the polysiloxane backbone, (ii) an acrylic organic compound, (iii) a dual function synergist and (iv) a photoinitiator.

The composition which contains at least one siloxane having ethylenically unsaturated, radically-polymerizable groups said reactive groups may be either terminal or pendant on the polysiloxane backbone (i.e., component (A)) useful for both the compositions and the methods of the invention includes those disclosed in U.S. Pat. No. 6,211,322; 6,268,404, and U.S. Pat. No. 10,465,032, the contents of which are herein incorporated by reference in their entirety. In particular, component (A) useful for the invention includes a composition which contains at least one siloxane having ethylenically unsaturated, radically polymerizable groups, and also comprising at least one hydrocarbon which has 2 to 6 ethylenically unsaturated, radically polymerizable groups said reactive groups may be either terminal or pendant on the polysiloxane backbone, for example: component (A) is a composition comprising components (I) 1 to 90 wt %, based on the sum of all components of the composition, of one or more hydrocarbons consisting of the elements carbon, hydrogen and oxygen and having 2 to 6 ethylenically unsaturated, radically polymerizable groups and at least one oxyethylene group; (II) 10 to 99 wt. %, based on the sum of all components of the composition, of one or more organomodified silicones having 50 to 500, preferably 60 to 300, more preferably 70 to 200, especially preferably 80 to 180 silicon atoms, it being possible for 0.4% to 10%, preferably 0.6% to 8%, more preferably 0.8 to 7% of the silicon atoms to carry ethylenically unsaturated, radically polymerizable groups, and it being possible for one silicon atom to carry one, two or three such groups; and optionally (III) 0 to 70 wt. %, based on the sum of all components of the composition, of one or more organomodified silicones having 4 to 40, preferably 10 to 30, silicon atoms, where 15% to 100%, preferably 20% to 50% of the silicon atoms have ethylenically unsaturated, radically polymerizable groups, with component (I) being preferably free of silicon atoms. With further preference, the hydrocarbons of components (I), (H) and (HI) have groups, as ethylenically unsaturated, radically polymerizable groups, that are selected from acrylic and/or methacrylic ester functions, more preferably acrylic ester functions. The hydrocarbon of component (I) preferably has 1 to 25, more to 5, oxyethylene groups per ethylenically unsaturated, radically polymerizable group, more preferably 1 to 25, very preferably 1 to 5, oxyethylene groups per acrylic and/or methacrylic ester function. With further preference, the hydrocarbon of component (I), as well as the at least one oxyethylene group, also has oxypropylene groups, in which case, more preferably, the number of oxypropylene groups is lower than the number of oxyethylene groups; with particular preference, only a maximum of 20% of the oxyalkyl groups are not oxyethylene groups, based on the total number of oxyalkyl groups in component (I).

In a particular embodiment, component (A) useful for the compositions and methods of the invention is selected from a composition comprising any of the following components I, II and/or III:

Component I:
E-I-1: Ethoxylated (according to product description, 3 ethylene oxide units in total) trimethylolpropane triacrylate, Miramer 3130, Rahn AG, Germany
E-I-2: Ethoxylated (according to product description, 20 ethylene oxide units in total) trimethylolpropane triacrylate, SR 415, Sartomer, France
E-I-3: Polyethylene glycol 600 diacrylate (according to product description, Mw 700 g/mol; corresponds to glycol with 12 ethylene oxide units), Ebecryl® 11, Allnex, Ebecryl is a trademark of Cytec Surface Specialties S. A. Anderlecht, Belgium
E-I-4: Ethoxylated and propoxylated (according to ¹H-NMR 1.2 propylene oxide and 5 ethylene oxide units in total) pentaerythritol tetraacrylate, Ebecryl® 40, Allnex, Ebecryl is a trademark of Cytec Surface Specialties S. A. Anderlecht, Belgium

Component II:
E-II-1: An exclusively terminally modified silicone with N=50, where N is the number of silicon atoms in the molecule. Prepared by process described in U.S. Pat. No. 6,211,322 via a corresponding hydrogensiloxane by hydrosilylation with trimethylolpropane monoallyl ether and subsequent esterification with acrylic acid, to give 4 acrylate groups per molecule; correspondingly, 4% of the silicon atoms are acrylated.
E-II-2: An exclusively terminally modified silicone with N=100. Prepared as E-II-1; correspondingly, 2% of the silicon atoms are acrylated.
E-II-3: An exclusively terminally modified silicone with N=200. Prepared as E-II-1; correspondingly 1% of the silicon atoms are acrylated.
E-II-4: An exclusively terminally modified silicone with N=300. Prepared as E-II-1; correspondingly 0.67% of the silicon atoms are acrylated.
E-II-5: An exclusively terminally modified silicone with N=100. Prepared by process described in U.S. Pat. No. 6,211,322 via a corresponding hydrogensiloxane by hydrosilylation with 5-hexen-1-ol and subsequent esterification with acrylic acid, to give 2 acrylate groups per molecule; correspondingly, 2% of the silicon atoms are acrylated.

Component III
S-II-1: An exclusively laterally modified silicone with N=100. Prepared by process described in U.S. Pat. No. 4,978,726 via a hydrogensiloxane with 6 pendant SiH groups, by hydrosilylation with allyl glycidyl ether and subsequent ring opening with acrylic acid, to give 6 acrylate groups per molecule; correspondingly, 6% of the silicon atoms are acrylated.
S-II-2: A terminally and laterally modified silicone with N=150. Prepared by process described in U.S. Pat. No. 6,211,322 via a hydrogensiloxane having 6 pendant and 2 terminal SiH groups, by hydrosilylation with 5-hexen-1ol and subsequent esterification with acrylic acid, to give 8 acrylate groups per molecule; correspondingly, 5.3% of the silicon atoms are acrylated.

Component III:
S-III-1: An exclusively laterally modified silicone with N=40. Prepared by process described in U.S. Pat. No. 4,978,726 via a hydrogensiloxane with 6 pendant SiH groups, by hydrosilylation with allyl glycidyl ether and subsequent ring opening with acrylic acid, to give 6 acrylate groups per molecule; correspondingly, 15% of the silicon atoms are acrylated.
S-III-2: An exclusively laterally modified silicone with N=10. Prepared by process described in U.S. Pat. No. 4,978,726 via a hydrogensiloxane with 5 pendant SiH groups, by hydrosilylation with allyl glycidyl ether and subsequent ring opening with acrylic acid, to give 5 acrylate groups per molecule; correspondingly, 50% of the silicon atoms are acrylated.
S-III-3: An exclusively laterally modified silicone with N=20. Prepared by process described in U.S. Pat. No. 4,978,726 via a hydrogensiloxane with 6 pendant SiH groups, by hydrosilylation with allyl glycidyl ether and subsequent ring opening with a mixture of 15% acetic acid and 85% acrylic acid, to give 5.1 acrylate groups per molecule; correspondingly, 25.5% of the silicon atoms are acrylated.

Exemplary component (A) useful for the compositions and methods of the invention is selected from the following compositions (content figures in wt. % based on the sum total of the recited components):

| Example | Component I | [wt %] | Component II | [wt %] | Component III | [wt %] |
|---|---|---|---|---|---|---|
| E-A | E-I-1 | 10 | E-II-2 | 70 | S-III-3 | 20 |
| E-B | E-I-2 | 10 | E-II-2 | 70 | S-III-3 | 20 |
| E-C | E-I-3 | 10 | E-II-2 | 70 | S-III-3 | 20 |
| E-D | E-I-4 | 10 | E-II-2 | 70 | S-III-3 | 20 |
| E-E | E-I-1 | 10 | E-II-1 | 70 | S-III-3 | 20 |
| E-F | E-I-1 | 10 | E-II-3 | 70 | S-III-3 | 20 |
| E-G | E-I-1 | 10 | E-II-4 | 70 | S-III-3 | 20 |
| E-H | E-I-1 | 10 | E-II-5 | 70 | S-III-3 | 20 |
| E-I | E-I-1 | 10 | S-II-1 | 70 | S-III-3 | 20 |
| E-J | E-I-1 | 10 | S-II-2 | 70 | S-III-3 | 20 |
| E-K | E-I-1 | 10 | E-II-2 | 70 | S-III-1 | 20 |
| E-L | E-I-1 | 10 | E-II-2 | 70 | S-III-2 | 20 |
| E-M | E-I-1 | 5 | E-II-2 | 95 | — | — |
| E-N | E-I-1 | 30 | E-II-2 | 70 | — | — |
| E-O | E-I-1 | 80 | E-II-2 | 20 | — | — |
| E-P | E-I-1 | 2 | E-II-2 | 60 | S-III-3 | 38 |

In a particular embodiment, Component II is one or more compounds of the formula (I),

M¹ₐM²₂D¹_{c}D²_{d} (I)
where
M¹=[R¹₃SiO_{1/2}],
M²=[R¹₂R²SiO_{1/2}],
D¹=[R¹₂SiO_{2/2}],
D²=[R¹R²SiO_{2/2}],
a=0 to 2,
b=0 to 2, and a+b=2,
c=50 to 490, preferably 60 to 290, more preferably 70 to 190, especially
preferably 80 to 170,
d=0 to 15, preferably 0 to 10,
and the ratio of the sum (b+d) to the sum (c+d+2) is from 0.004 up to 0.1, preferably 0.006 to 0.8,
and more preferably 0.008 to 0.7;
and the sum (c+d+2) is 50 to 500, preferably 60 to 300, more preferably 70 to 200, especially preferably 80 to 180,
   R¹ denotes identical or different aliphatic hydrocarbons having 1 to 10 carbon atoms or aromatic hydrocarbons having 6 to 12 carbon atoms, preferably methyl and/or phenyl groups, especially preferably methyl groups,
   R2 denotes identical or different hydrocarbons which have 1 to 5 identical or different ester functions, the hydrocarbon being linear, cyclic, branched and/or aromatic, preferably linear or branched, and the ester functions being selected from ethylenically unsaturated, radically polymerizable ester functions and from ester groups which are not radically polymerizable.

In another particular embodiment, the components (III) are one or more compounds of the formula (II),

M¹ₑM³_{f}D¹_{g}D³ₕ (II)
where
M¹=[R¹₃SiO_{1/2}],
M³=[R¹₂R³SiO_{1/2}],
D¹=[R¹₂SiO_{2/2}],
D³=[R¹R³SiO_{2/2}],
e=0 to 2,
f=0 to 2, preferably zero, and e+f=2,
g=0 to 38, preferably 10 to 26,
h=0 to 20, preferably 4 to 15,
and the ratio of the sum (f+h) to the sum (g+h+2) is from 0.15 up to 1,
preferably 0.2 to 0.5,
and the sum (g+h+2) is 4 to 40, preferably 10 to 30,
and the radicals ¹ are defined as specified for formula (I),
   R³ denotes identical or different hydrocarbons which have 1 to 5 identical or different ester functions, the hydrocarbon being linear, cyclic, branched and/or aromatic, preferably linear or branched, and the ester functions being selected from ethylenically unsaturated, radically polymerizable ester functions and from ester groups which are not radically polymerizable.

The ethylenically unsaturated, radically polymerizable ester functions of radicals R³ in compounds of the formula (II) are preferably those selected from acrylic and/or methacrylic ester functions, more preferably acrylic ester functions.

The ester groups that are not radically polymerizable of the radicals R³ in compounds of the formula (II) are preferably monocarboxylic acid radicals. The ester groups that are not radically polymerizable are preferably selected from the acid radicals of the acids acetic acid, propionic acid, butyric acid, valeric acid and benzoic acid, more preferably acetic acid. More preferably, the monocarboxylic acid radicals are present in a numerical fraction of 3% to 20%, preferably 5% to 15%, based on the number of all ester functions of the compounds of the formula (II).

The ethylenically unsaturated, radically polymerizable ester functions of radicals R² in compounds of the formula (I) are preferably those selected from acrylic and/or methacrylic ester functions, more preferably acrylic ester functions.

The ester groups that are not radically polymerizable of the radicals R² in compounds of the formula (I) are preferably monocarboxylic acid radicals. The ester groups that are not radically polymerizable are preferably selected from the acid radicals of the acids acetic acid, propionic acid, butyric acid, valeric acid and benzoic acid, more preferably acetic acid. More preferably, the monocarboxylic acid radicals are present in a numerical fraction of 0% to 20%, preferably greater than 0% to 15%, based on the number of all ester functions of the compounds of the formula (II).

In a preferred embodiment, Component A includes a (meth)acrylated polydiC₁₋₈alkylsiloxane, in one embodiment, a (meth)acrylated polydimethylsiloxane, in another embodiment, those selected from siloxanes and silicones, 3-[3-(acetyloxy)-2-hydroxypropoxy]propyl Me, di-Me, 3-[2-hydroxy-3-[(1-oxo-2-propen-1-yl)oxy]propoxy]propyl Me (e.g., TEGO® RC 711, TEGO® RC 715 and TEGO® SB6705 commercially available from Evonik Corporation); and the acrylated polydimethylsiloxane is siloxanes and silicones, di-Me, hydrogen-terminated, reaction products with acrylic acid and 2-ethyl-2-[(2-propenyloxy)methyl]-1,3-propanediol (e.g., TEGO® RC 902, TECO® RC 922 commercially available from Evonik Corporation), available from Evonik Corporation. Component A is present at 70-95 wt. %, in a particular embodiment, 85-95 wt. %, in still another embodiment, 72-89 wt. %, in still another particular embodiment, selected from 87 wt. %, 90 wt. % and 94 wt. %, based on the total weight of the composition.

Acrylic organic compound, useful for the compositions and methods of the invention include those disclosed in U.S. Pat. 10,465,032, the contents of which are herein incorporated by reference in their entirety. In one embodiment, the acrylic organic compound is (i) an organic compound comprising ethylenically unsaturated, radically polymerizable group, preferably (meth)acrylated function or (ii), preferably trimethylolpropane triacrylate (TMPTA) or 1,6-Hexanediol diacrylate (HDDA), or (iii) a low viscosity, tetra-functional polyol acrylate such as Ebecryl® 45. Generally, the compositions of the invention contains 0-10 wt. %, in a particular embodiment, 5-10 wt. %, in still another embodiment, 0-5 wt. % of the acrylated organic compound, in certain embodiment, selected from 3 wt. % and 7 wt. % of the acrylated organic compound based on the total weight of the composition.

Acrylic modified synergist useful for the compositions and methods of the invention include any synergist which can donate a hydrogen atom and work in conjunction with the photoinitiator to increase free radical reactivity and further enhance responsiveness of the composition/system to longer wavelength light emitted from LED lamps. Examples of such synergist include acrylic modified mercapto synergist or acrylic modified amine synergist, in particular embodiment, acrylic modified oligoamine synergist. Preferably, the acrylic modified synergist is selected from any oligoamine synergists such as Genomer 5142 from Rahn AG and amine modified polyether acrylate such as LED 03 available from Allnex. In another embodiment, the acrylic modified mercapto synergist is Ebecryl® LED 02;

Photoinitiators useful for the compositions and methods of the invention include those that match the emission spectra of the UV irradiation lamp. For sufficient reaction to occur, the UV absorbance of the photoinitiator package must match the emission spectra of the lamp system. Solubility of the photoinitiator in the silicone system is another important consideration. The photoinitiator, or photoinitiator combination may be selected from a variety of commercially available products, in one particular embodiment, the photoinitiator is a specially blended photoinitiator combination comprised any of the following components bis(2,4,6-trimethylbenzoyl)phenylphosphine oxide, ethyl(2,4,6-trimethylbenzoyl)-phenylphosphinate and 2-hydroxy-2-methyl-1-phenylpropanone or any combination thereof including Omnirad 2100 from IGM Resins.

In one embodiment, the curing is performed under a UV lamp, which may be a mercury-vapor UV lamp or an LED UV lamp. The irradiation may be with an output of UV light in the range of 200-400 nm, in a particular embodiment, 220-365nm, in another embodiment, 350-405 nm, in still another embodiment, 385-405 nm. In another embodiment, the curing is performed under electron beam irradiation.

Further, this invention is directed to a silicon release liner as part of an adhesive label produced by free radical polymerization curing of the compositions of the invention located between a UV/EB transparent protective film and a substrate that has passed over a compression cylinder.

The UV/EB transparent protective film useful for the invention may be any film that removes surface oxygen, allowing the curing process to be carried out without requiring inertization and/or oxygen scavenging agent traditionally required (e.g., via mechanical inertization). Such film includes but is not limited to polyethylene and polypropylene film and film commercially available from Breit Technology. Depending on the desired utility, such film may be a decorative/holographic or a non-decorative film, and in certain embodiment, such film can provide a matte, glossy or ultrahigh gloss finish. The film acts as an embossing tool to manipulate the surface of the UV/EB curable silicone compositions.

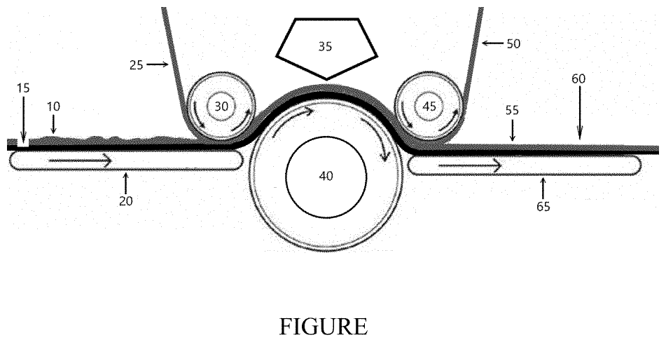

The UV/EB curable silicone compositions or the Compositions of the invention may be used in conjunction with the modified Breit Technologies' Cast and Cure™ process (shown in FIG. 1), also known as film casting, or similar film casting process, wherein the UV/EB curable silicone compositions or the Compositions of the invention and the UV/EB transparent protective film such as the specialty polypropylene protective films are used, e.g., to create diffractive surfaces to produce unique finishes for the printing and packaging industries. According to Breit Technologies: “Cast and Cure™ (C2™) [process] is a decorative coating process that integrates “casting” and “curing” techniques to form a consistent high-quality surface that can include ultra-high gloss, matte and holographic finishes on a variety of substrates. This effect can be created in both sheet-fed and web fed (flexo and gravure) environments. C2™ film is an excellent application for the decorative print market and can be incorporated with security and anti-counterfeiting features.”

To achieve the effect, the UV/EB curable silicone compositions or the Compositions of the invention are applied to a substrate based on either spot or flood coverage needs. Once the UV/EB curable silicone composition or the Compositions of the invention is applied, the UV/EB transparent protective film such as the special Cast and Cure propylene protective film, micro-engraved with an image or pattern or not (e.g., is untreated, smooth and flat), is temporarily laminated to the coated substrate. The film acts as an embossing tool to manipulate the surface of the coating on a submicron scale.

The laminated coated substrate is then UV- or EB-cured with the UV/EB transparent protective casting film still in place. Finally, the film is delaminated and stripped away, leaving the desired pattern on the surface of the substrate. No material or film is transferred to the surface, so the film can be rewound and used multiple times.

The above described technology works equally well with both mercury-vapor UV lamps as well as LED UV lamps. Often, the surface hardness of films cured with an LED lamp system suffer in comparison to films cured by traditional mercury-vapor lamps. The process of the invention which incorporates the Cast and Cure process along with the polypropylene UV/EB transparent protective film, however, removes surface oxygen, allowing the curing process to be carried out without requiring inertization and oxygen scavenging agent traditionally required, allowing for improved cure performance of the UV/EB curable silicone compositions or the Compositions of the invention even at reduced lamp intensities.

The Cast and Cure process is similar to the application of UV curable laminating adhesives used in products ranging from flexible packaging to complex electronic assemblies. One of the key challenges for UV cure laminating adhesives is to deliver enough energy to cure the adhesive, sandwiched between two substrates, to achieve strong bonding.

Without being bound to any particular theory, it is believed that the use of the UV/EB transparent protective films as described herein, such as the polypropylene or polyethylene film or films available from Breit Technology is one of several different strategies employed to mitigate the oxygen inhibition problem without the use of nitrogen inerting. The more popular chemical processes, such as incorporating oxygen scavengers, and increasing photo initiator concentration are most frequently investigated in the field. These practices are effective in many different hydrocarbon-based systems like inks and varnishes; however, to date, none of these techniques is proven effective with silicone release coatings. As mentioned previously, the silicone layers employed in the art are exceptionally thin (typically<1 micron) and the high flexibility of the silicon-oxygen chain in silicone provides “openings” which permit the rapid diffusion of oxygen molecules. LED lamps systems require specific formulations to adequately cure; the photo initiator combinations must respond to the longer wavelength of the UV radiation generated by LEDs. Currently, there are no known silicone release coatings, which will cure with an LED lamp system as provided in the current invention. The current invention solves an unmet need in the industry.

The new and novel methods of the invention combine the Cast and Cure technique as described herein with any UV/EB curable silicone compositions, but particularly with the silicone release coating compositions of the invention such as the Compositions of any of formulae 1.1-1.10, on e.g., the paper or polymer film substrate, produces surprisingly good cure results using an LED lamp system at low intensities (5 W/cm²) and relatively high line speeds. Eliminating the need for nitrogen inerting, reducing the complexity of the operation and potentially lowering the overall cost of the process opens the door for more and varied applications of free-radical, cure silicone release coatings.

### Coating Formulation

As the most preferred technique of the subject process uses an LED lamp system, a specially formulated silicone release coating composition of the invention is required. Traditional mercury-vapor UV lamp systems emit a broad spectrum of actinic radiation with peak intensities in the UVC region (100-280 nm); whereas, LED lamp systems emit a nearly monochromatic wavelength in the high UVA region (315-400 nm). This difference in actinic radiation usually necessitates a reformulation of the release coating to match UV output. It is believed no commercially available silicone release coating products for LED lamp systems. Typically, the surface hardness of films cured with an LED lamp system suffer in comparison to films cured by traditional mercury-vapor lamps. Compensating for the difference in UV output generally requires changing the photoinitiator among other challenges.

### Typical Coating Method

For the purpose of demonstration under laboratory conditions, silicone coated substrates may be prepared using a single-roll, manual lab coater (Model E-BC12M1) from Euclid Coatings, Inc. (http://www.euclidlabcoaters.com/sinqle roll.htm). Substrates such as Verso Aspect SCK paper and (2) biaxially oriented polypropylene film are used. The manual lab coater are operated at three different pressure ratings (30 psi, 32 psi and 34 psi) to control the coat weight of the applied silicone. To improve wetting and adhesion, all substrates are corona treated prior to coating. One end of the substrate is attached to the surface width of the roll by using a piece of tape. The air pressure to the wiper blade may be regulated to adjust coating application thickness. The coating composition of the invention is poured down between where the blade edge touches against the roll, followed by turning the roll one revolution, and removing the coated substrate. The roll is cleaned and the process for each sample is repeated.

### Mechanical Inerting Curing Process

Silicone-coated substrates produced via the above described process are cured using a modified version of the Breit Technologies Cast and Cure™, also known as film casting, technique. Rather than using a micro engraved film for producing decorative images, the film is untreated, smooth and flat. To ensure that the silicone release coating composition of the invention remains with the substrate when the laminating polypropylene UV transparent protective film is removed, it is imperative that the top, laminating film have a lower surface energy than the substrate by corona treatment. To ensure good coating quality and adhesion, it is preferred that the substrate surface energy be greater than 40 dynes. The Cast and Cure™ equipment is outfitted with two Excelitas LED lamps situated side by side. The first lamp is an Omnicure AC7150 and the second lamp is an Omnicure AC7300. According to the Omnicure AC7 Series User Guide, the peak irradiance of the aforementioned LED lamps at 395 nm is 5 W/cm2, when measured at 1 mm from the window face. To demonstrate the versatility of the process, samples may be prepared with lamp intensity at two different settings (1) 25% of maximum and (2) 100% of maximum. Samples may be passed under the lamp system at a line speed of 75 feet/minute (fpm). Cured samples may be tested for extent of cure and release performance per the process outlined below. The process is summarized in FIG. 1.

### Test Methods

The Quick Subsequent Adhesion (QSA) test may be used to determine the degree of cure of the silicone release coating composition of the invention. The measurement may be done with a piece of silicone coated substrate, a piece of OPP film, several strips TESA® 7475 test tape, a FINAT test roller (2 kg rubber roller) and a tensile tester or similar machine. The tensile tester should be capable of peeling a laminate at an angle of 180° at a peel rate of 300 mm per minute.

To run the test, a strip TESA® 7475 is laminated to the silicone coated substrate by means of the test roller; roll 5 times in each direction over the laminate, at a speed of approximately 200 mm/s. A piece of OPP film is fixed by a double side adhesive tape on the test bed of the release tester. After a contact time of 60 seconds the adhesive tape is removed from the siliconized substrate and laminated to the OPP film (5 times by test roller). After 30 seconds contact time, the release tester is started for testing and the result is recorded. Several tests should be carried out for each sample and using a new piece of OPP film for each test.

As a reference, the release of an untreated TESA® 7475 strip (no contact with silicone) is measured. The tape is laminated to the OPP film in the same manner as the described test above, using the same procedure for laminating and peeling.

Because the adhesive force is dependent on temperature, testing takes place in a temperature-controlled environment so that results may be compared. In such an environment, the reference values taken in the morning can be used to compare QSA measurements all day.

The QSA value is given by the ratio of the test value divided by the (average) reference value. The accuracy of the QSA test method is ±2.5% (3 sigma).

$$\% Q S A = \frac{release of the test stripes}{average release of the standard tape ( reference )} \times 100$$

### Release

Release force is defined as the force required to separate a pressure sensitive adhesive (PSA) coated material from its protective sheet (liner) or vice versa, under specified aging conditions and at a specified angle and speed. The measurement may be done with a piece of silicone coated substrate, standard PSA test tapes, a FINAT test roller (2 kg rubber roller), a hot air oven capable of maintaining a temperature of 40° C.±5° C., metal pressure plates loaded to give a pressure of pressure of 70 g/cm² (11 Ib/int) on the test pieces, and a tensile tester or similar machine. The tensile tester is capable of peeling a laminate at an angle of 180° at a peel rate of 300 mm per minute.

The silicone coated substrate may be tested against the standard test tapes and may be tested against a PSA tape which simulates the end application (as specified by test requestor). Take a representative sample of the silicone coated substrate (minimum dimensions 450mm×250mm). Apply to this, using light finger pressure, the test tape in strips along the machine direction. NOTE: Do not contaminate the silicone surface to be tested. Cut the test strips approximately 25 mm wide and 175 mm in the machine direction. The cuts should be clean and straight. Roll the strips five times in each direction with the standard FINAT test roller at a speed of approximately 200 mm per second. Use only the weight of the roller. At least three strips from each sample should be prepared for each aging condition to be tested. In the case of very low release force, wider samples may be prepared. However, the release force should still be expressed as release force per 25 mm (1 inch) width. Place the prepared test strips between two flat metal or glass plates under a pressure of 70 g/cm2 (11Ib/in2) to ensure good contact between the silicone and the adhesive. Stack no more than five samples between plates. Place the samples in the specified aging conditions. After storage in this manner for the specified time, remove the test strips from between the plates and keep them for not more than four hours at the standard test conditions of 23° C.±2° C. and 50% RH ±5% RH.

Fix each strip in the machine so that the test tape can be stripped from the silicone coated substrate at the specified angle. (If the silicone coated substrate is to be stripped from the test tape, it must be noted in the report.) Set the machine to the specified speed. Carry out the test. Take a minimum of three readings from the center portion of the test strip. If the test is computer driven, follow the directions in the program. Record the

Average, Maximum, and Minimum values for each test strip.

Release force is expressed in grams per inch (equivalent to centinewtons per 25 mm) width. It is the average of all test strips for each specified condition. Include the average Maximum and the average Minimum for each condition in the report. In the tables referenced below the acronyms 1RT specifies 1 day at room temperature (25° C.) and 7AA indicates accelerated aging where the samples are stored 7 days at elevated temperature (40° C.).

### EXAMPLES

The following examples are provided to illustrate the inventions and do not limit the scope of the claims.

Example #1. A formulation of the following composition, and in accordance with the guidelines detailed above, is prepared by standard high-speed, high-shear mixing techniques familiar to those skilled in the art. The formulation is coated per the prescribed methods above, using two different substrates and applying two different coat weights of silicone as detailed in the accompanying tables. The two substrates are BOPP and SCK as defined above in the Coating Method section. The QSA test is only performed on the higher coat weight samples as the increased coating thickness represents the worst-case scenario.
Acrylated poly dimethyl siloxane TEGO® SB6705: 87.0 wt. %
Acrylic Monomer Ebecryl® 45: 7.0 wt. %
Acrylated amine synergist Ebecryl LED 03: 5.0 wt. %
Photo initiator Omnirad 2100: 1.0 wt. %

Example #2. A formulation of the following composition, and in accordance with the guidelines detailed above, is prepared by standard high-speed, high-shear mixing techniques familiar to those skilled in the art. The formulation is coated and per the prescribed methods above, using two different substrates and applying two different coat weights of silicone as detailed in the accompanying tables. The two substrates are BOPP and SCK as defined above in the Coating Method section. The QSA test is only performed on the higher coat weight samples as the increased coating thickness represents the worst-case scenario.
Acrylated poly dimethyl siloxane TEGO® SB6705: 90.0 wt. %
Acrylic monomer Ebecryl® 45: 7.0 wt. %
Acrylated amine synergist GENOMER 5142: 1.0 wt. %
Photoinitiator Omnirad 2100: 2.0 wt. %

In a first set of experiments, the compositions of Example 1 and Example 2 are exposed to the lamp system wherein two Excelitas LED lamps are situated side by side. The first lamp is an Omnicure AC7150 and the second lamp is an Omnicure AC7300. According to the Omnicure AC7 Series User Guide, the peak irradiance of the aforementioned LED lamps at 395 nm is 5 W/cm2, when measured at 1 mm from the window face. Experiments are performed at lamp intensity settings of 75% and samples are passed under the light at line speeds of 75 feet/minute (fpm). The conditions and results are provided in Table One.

In a second set of experiments, the compositions of Example 1 and Example 2 are exposed to the Phoseon FJ240 with higher intensity lamp system. According to the company web site, the peak irradiance of the Fire Jet® FJ240 lamp is 16 W/cm2 at 395 nm. Again, to demonstrate versatility, experiments are performed at two different lamp intensity settings (1) 75% and (2) 50% and samples are passed under the light at line speeds varying from 75 feet/minute (fpm) up to a maximum of 225 feet/minute (fpm). The conditions and results are provided in Table Two.

To demonstrate the effectiveness of the subject process a third set of experiments are performed wherein, the identical formulations are coated and cured in an open atmosphere environment exposed to oxygen using a standard, high-intensity mercury vapor lamp system. The results are provided in Table Three and these samples are identified as Control #1 and Control #2 corresponding to Example #1 and Example #2 respectively.

TABLE ONE
Mechanical Inerting Demonstration -
LED lamp 5 W/cm² @ 75 fpm

| | | Coat Weight | QSA | 1RT | 7AA |
|---|---|---|---|---|---|
| Sample ID | Substrate | (g/m²) | (%) | (gm/inch) | (gm/inch) |
| Example #1 | BOPP | 1.25 | 80 | 50 | 79 |
| Example #1 | BOPP | 1.18 | — | 50 | 63 |
| Example #1 | SCK | 1.58 | 77 | 44 | 81 |
| Example #1 | SCK | 1.28 | — | 47 | 64 |
| Example #2 | BOPP | 1.73 | 77 | 18 | 30 |
| Example #2 | BOPP | 1.59 | — | 25 | 37 |
| Example #2 | SCK | 1.67 | 84 | 14 | 17 |
| Example #2 | SCK | 1.38 | — | 17 | 24 |

10

TABLE TWO
Mechanical Inerting Demonstration -
LED lamp 16 W/cm² @ 75 fpm

| | | Coating | QSA | 1RT | 7AA |
|---|---|---|---|---|---|
| Sample ID | Substrate | Condition | (%) | (gm/inch) | (gm/inch) |
| Example #1 | BOPP | 75 fpm/50% | 100 | 18 | 22 |
| | | power | | | |
| Example #1 | BOPP | 75 fpm/25% | 98 | 14 | 14 |
| | | power | | | |
| Example #1 | BOPP | 225 fpm/75% | 96 | 18 | 19 |
| | | power | | | |
| Examples #1 | BOPP | 225 fpm/50% | 96 | 17 | 17 |
| | | power | | | |

TABLE THREE
Identical formulations cured in open
atmosphere with mercury vapor lamp

| | | Coat Weight | QSA | 1RT | 7AA |
|---|---|---|---|---|---|
| Sample ID | Substrate | (g/m²) | (%) | (gm/inch) | (gm/inch) |
| Control #1 | BOPP | 1.25 | <50 | Not Tested | Not Tested |
| Control #2 | BOPP | 1.25 | <50 | Not Tested | Not Tested |

The Quick Subsequent Adhesion (QSA) test is used to determine the degree of cure of a silicone release coatings; results greater than 80% are qualified as excellent, 75-80% are adequate, 60-75% are marginal and anything below 50% is deemed unacceptable. The above experiments show that Examples 1 and 2, when cured through a mechanical inerting method such as the modified Breit Technologies Cast and Cure™ process yield results indicating high adequate to excellent cure performance (77%-84% QSA). Increasing the lamp intensity to 16 W/cm² or higher, as shown in Table Two translates to improved cure (96-100% QSA) and faster line speeds. Extent of cure is dictated by three dominate variables: light intensity, formulation quality and oxygen exposure. When the identical formulations are cured with a high intensity lamp system but also in a high oxygen atmosphere (>20,000 ppm) the cure performance drops to an unacceptable level (see Control #1 and Control #2).

The composition of Example 1 and Example 2 also demonstrate the versatility of the process to vary release performance. The release performance shown is between Easy Release, defined as 10-30 grams/inch, and Controlled Release, defined as 30-200 grams/inch.

Notwithstanding that the numerical ranges and parameters setting forth the broad scope of the invention are approximations, the numerical values set forth in the specific examples are reported as precisely as possible. Other than in the operating examples, or where otherwise indicated, all numbers expressing quantities of ingredients, reaction conditions, and so forth used in the specification and claims are to be understood as being modified in all instances by the term “about.” Any numerical value, however, inherently contains errors necessarily resulting from the standard deviation found in their respective testing measurements.

1. A composition, comprising;
based on a total weight of the composition,
(A) 70-95 wt. % of a further composition which contains at least one siloxane haying ethylenically unsaturated, radically-polymerizable groups, wherein said groups may be either terminal or pendant on a polysiloxane backbone;
(B) 0-10 wt. % of an acrylic organic compound;
(D) 1-8 wt. % of a photoinitiator.

2. The composition of claim 1, wherein component (A) is a (meth)acrylated polydiC₁₋₈alkylsiloxane.

3. The composition of claim 1, wherein the acrylic organic compound is
(a) a low viscosity, tetra-functional polyol acrylate,
(b) trimethylolpropane triacrylate (TMPTA), or
(c) 1,6-Hexanediol diacrylate (HDDA).

4. The composition of claim 1, wherein the composition comprises 1 to 5 wt. % of a mercapto synergist or an oligoamine synergist.

5. The composition of any of claim 1, wherein the photoinitiator is a special blended photoinitiator combination comprising bis(2,4,6-trimethylbenzoyl)phenylphosphine oxide, ethyl(2,4,6-trimethylbenzoyl)-phenylphosphinate, and 2-hydroxy-2-methyl-1-phenylpropanone,

6. A method for preparing a silicone-coated release liner, the method comprising:
(i) applying an ultraviolet or electron beam (UV/EB) curable silicone composition to a substrate, to obtain a coated substrate;
(ii) laminating a UV/EB transparent protective film to the coated substrate of (i), to obtain a laminated combination: and
(iii) exposing the laminated combination of step (ii) to ultraviolet (UV) or electron beam (EB) radiation.

7. The method of claim 6, wherein the UV/EB transparent protective film is selected from the group consisting of polypropylene film, polyethylene film, and a film produced by a film casting process; and/or
wherein the UV/EB transparent protective film is a decorative, holographic, or a non-decorative film; which provides a matte, glossy, or ultra high gloss finish.

8. The method of claim 6, wherein the UV/EB curable silicone composition of is a UV curable silicone composition, and the laminated combination of (ii) is exposed to mercury vapor lamp UV radiation in (iii).

9. The method of claim 6, wherein the UV/EB curable silicone composition comprises:
based on a total weight of the UV/EB curable silicone composition,
(A) 70-95 wt. % of a further composition which contains at least one siloxane having ethylenically unsaturated, radically-polvmerizable groups, wherein the groups may be either terminal or pendant on a polysiloxane backbone;
(B) 0-10 wt. % of an acrylic organic compound; and
(D) 1-8 wt. % of a photoinitiator,
and
wherein the laminated combination of (ii) is exposed to light emitting diodes (LED) in (iii).

10. The method of claim 6, wherein the UV/EB curable silicone composition is an EB curable silicone composition, and the laminated combination of (ii) is exposed to electron beam radiation source in (iii).

11. The method of claim 6, wherein the substrate has a surface energy of greater than 40 dynes.

12. The method of claim 6, wherein the substrate is selected from the group consisting of polypropylene, polyethylene, polyethylene terephthalate (PET), polyester, bi-axially oriented polypropylene (BOPP), biaxially-oriented polyethylene terephthalate (BoPET), high density polyethylene, low density polyethylene, and polypropylene plastic resin.

13. The method of claim 6, further comprising:
(iv) delaminating the UV-EB transparent protective film from a UV/EB cured silicone coated substrate.

14. The method of claim 6, wherein said method does not require gas inertization or an oxygen scavenging agent.

15. A silicone release liner made from the method of claim 6.

16. The composition of claim 1, further comprising:
(C) 1 to 5 wt. % of an acrylated synergist.

17. The composition of claim 2, wherein component (A) is at least one selected from the group consisting of
(i) di-Me, hydrogen-terminated, reaction products with acrylic acid and 2-ethyl-2-[(2-propenyloxy)methyl]-1,3-propanediol; and
(ii) siloxanes and silicones, 3[3-(acetyloxy)-2-hydroxypropoxy]propyl Me, di-Me, 3-[2-hydroxy-3-[(1-oxo-2-propen-1-yl)oxy]propoxyl]propyl Me.

18. The method of claim 6, wherein the UV/EB curable silicone composition comprises a (meth)acrylated polysiloxane.

19. The method of claim 6, wherein the UV/EB curable silicone composition comprises:
based on a total weight of the UV/EB curable silicone composition,
(A) 70-95 wt. % of a further composition which contains at least one siloxane having ethylenically unsaturated, radically-polymerizable groups, wherein the groups may be either terminal or pendant on a polysiloxane backbone;
(B) 0-10 wt. % of an acrylic organic compound; and
(D) 1-8 wt. % of a photoinitiator.

20 The method of claim 8, wherein the mercury vapor lamp UV radiation in (iii) is in a range of 220-400 nm.
